(19) United States
(12) Patent Application Publication
(10) Pub. No.: US 2006/0256132 A1
(43) Pub. Date: Nov. 16, 2006

(54) Refrigerator having user avatar display function

(75) Inventors: Jong-Min Shin, Nam-Ku (KR); Sun-Cheol Bae, Masan-shi (KR); Su-Won Lee, Changwon-shi (KR); Jae-Seng Sim, Masan-shi (KR); Eun-Jeong Kim, Changwon-shi (KR); Eun-Young Park, Jung-ku (KR); Deok-Hyun Youn, Ahnyang-shi (KR); Yong-Chol Kwon, Changwon-shi (KR); Byung-Koo Kong, Gimhae-shi (KR); Ku-Young Son, Buk-ku (KR)

Correspondence Address: FLESHNER & KIM, LLP, P.O. BOX 221200, CHANTILLY, VA, 20153, US

(73) Assignee: LG Electronics Inc.

(21) Appl. No.: 11/359,434

(22) Filed: Feb. 23, 2006

(30) Foreign Application Priority Data
May 13, 2005 (KR) 10-2005-0040201

(51) Int. Cl. G09G 5/00

(52) U.S. Cl. 345/619

(57) ABSTRACT

The present invention discloses a refrigerator having a user avatar display function which can store avatars of each user, identify users, and display the avatars corresponding to the identified users. The refrigerator having the user avatar display function includes a photographing means for photographing images of users, a storing means for storing user information for identifying the users, and avatar information having avatars corresponding to the users and/or user information, a display means for displaying the avatars, and a control means for reading the user information, comparing the user information with the images of the users photographed by the photographing means, reading the avatar information according to the comparison result, and displaying the avatars of the users included in the read avatar information on the display means.

### TECHNICAL FIELD

The present invention relates to a refrigerator, and more particularly, to a refrigerator having a user avatar display function which can store avatars of each user, identify users, and display the avatars corresponding to the identified users.

### BACKGROUND ART

A conventional refrigerator includes a display unit for providing information on the refrigerator and controlling the refrigerator, such as an LCD panel. A user interface is displayed on the display unit. The user interface displays a temperature inside a refrigerating chamber, a temperature inside a freezing chamber and a service state of a dispenser (water, flake ice, etc.) in the form of numbers, characters or icons. The display unit includes an input unit (for example, buttons) for controlling the temperature inside the refrigerator and the service of the dispenser.

FIG. 1 is a structure view illustrating a display unit of a conventional refrigerator. Referring to FIG. 1, the display unit displays a service type of a dispenser (cubic ice, flake ice), a set temperature of a freezing chamber and a set temperature of a refrigerating chamber, and has an input means at its lower portion.

The conventional refrigerator does not have a function of identifying users and providing data to the identified users.

### DISCLOSURE OF THE INVENTION

The present invention is achieved to solve the above problems. An object of the present invention is to provide a refrigerator having a user avatar display function which can identify users and display avatars corresponding to the identified users.

Another object of the present invention is to provide a refrigerator having a user avatar display function which can identify users and transmit messages of another users to the identified users.

Yet another object of the present invention is to provide a refrigerator having a user avatar display function which can visually notify actions and states of users by changing avatars according to the actions and states of the users.

In order to achieve the above-described objects of the invention, there is provided a refrigerator having a user avatar display function, including: a photographing means for photographing images of users; a storing means for storing user information for identifying the users, and avatar information having avatars corresponding to the users and/or user information; a display means for displaying the avatars; and a control means for reading the user information, comparing the user information with the images of the users photographed by the photographing means, reading the avatar information according to the comparison result, and displaying the avatars of the users included in the read avatar information on the display means.

According to another aspect of the invention, there is provided a refrigerator having a user avatar display function, including: a storing means for storing avatar information having avatars corresponding to users; a display means for displaying the avatars; and a control means for changing the avatars according to user-related information and displaying the avatars on the display means.

### BRIEF DESCRIPTION OF THE DRAWINGS

The present invention will become better understood with reference to the accompanying drawings which are given only by way of illustration and thus are not limitative of the present invention, wherein:

FIG. 1 is a structure view illustrating a display unit of a conventional refrigerator;

FIG. 2 is a block diagram illustrating a refrigerator having a user avatar display function in accordance with the present invention;

FIG. 3 is a block diagram illustrating a storing means of FIG. 2;

FIG. 4 is a flowchart showing a first example of the user avatar display function of the refrigerator in accordance with the present invention;

FIG. 5 is a flowchart showing a second example of the user avatar display function of the refrigerator in accordance with the present invention;

FIG. 6 is a flowchart showing a third example of the user avatar display function of the refrigerator in accordance with the present invention;

FIG. 7 is a flowchart showing a fourth example of the user avatar display function of the refrigerator in accordance with the present invention; and

FIG. 8 is a flowchart showing a fifth example of the user avatar display function of the refrigerator in accordance with the present invention.

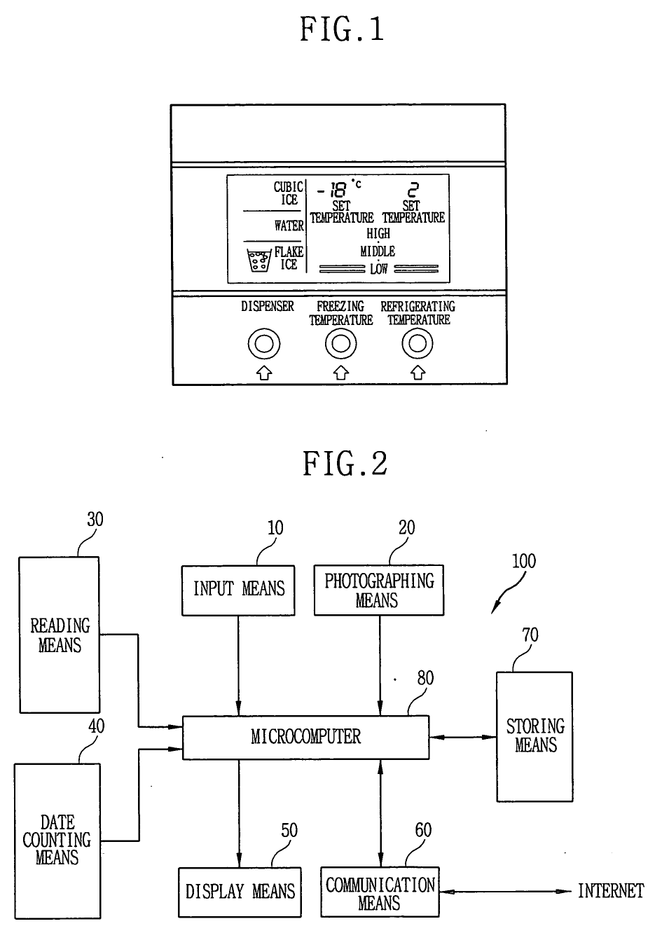

### BEST MODE FOR CARRYING OUT THE INVENTION

A refrigerator having a user avatar display function in accordance with the present invention will now be described in detail with reference to the accompanying drawings.

FIG. 2 is a block diagram illustrating the refrigerator having the user avatar display function in accordance with the present invention. As illustrated in FIG. 2, the refrigerator 100 includes an input means 10 for inputting a user command and/or data, a photographing means 20 for photographing images of users, a reading means 30 for reading an identifying means adhered to or printed on food and/or a food packing sheet, a date counting means 40 for counting a current date, a display means 50 for displaying avatars of the users, a communication means 60 for performing data communication with an external server (not shown) through an internet, a storing means 70 for storing at least user information for identifying the users and avatar information corresponding to the user information, and a microcomputer 80 for searching the identical user information by comparing the images of the users photographed by the photographing means 20 with the user information stored in the storing means 70, and displaying the avatars included in the avatar information corresponding to the searched user information on the display means 50, by controlling the aforementioned elements. The refrigerator 100 can further include a main microcomputer (not shown) for performing freezing and refrigerating control. The main microcomputer and the microcomputer 80 are connected through a communication line for data communication. Otherwise, the refrigerator 100 performs freezing and refrigerating control by the microcomputer 80. In addition, the refrigerator 100 includes a power supply means (not shown) for supplying power to each element.

In detail, the input means 10 allows the user to select the avatar for avatar formation, a photographing mode of the photographing means 20, and the user who is a message receiver and/or the corresponding avatar, and to input a text message. The microcomputer 80 reads avatar formation information (discussed later in detail) stored in the storing means 70, and displays the avatar formation information on the display means 50, so that the user can select the avatar from the displayed avatar formation information. When the user intends to obtain a user image or generate an image message, he/she can select the photographing mode of the photographing means 20. When the user intends to leave a message to another user, the user inputs the name of another user who is a message receiver or selects the corresponding avatar. Since the input means 10 has a keyboard structure, the user can input the text message by pressing characters. In addition, the input means 20 is used to select an avatar display service and an avatar change service by foods, input the user birthday, and select a biorhythm service. The input means 10 is related to the user interface displayed on the display means 50, and formed in a button or touch pad type.

The photographing means 20 photographs the images of the users. Here, the images of the users include iris images, fingerprint images or body shapes. The iris images and the fingerprint images are used for iris and fingerprint recognition. The photographing means 20 must have sufficient definition for the recognition. The body shapes include face shapes such as full-faces and profiles. In this case, the photographing means 20 can have a function of a general digital camera or digital camcorder. In order to perform the digital camcorder function, the photographing means 20 includes a mike for recording voice.

The reading means 30 includes an RF reading unit (not shown) for reading food information stored in an RFID displayed on or adhered to food, and/or a barcode reading unit (not shown) for reading food information of a barcode. Here, the food information includes at least a name (kind) and/or quantity of food. It is also possible to input the quantity of food by the input means 10.

The RF reading unit can be installed near the display means 50 (on the front surface of the refrigerator) for user's convenience or in the refrigerator. In the case that the RF reading unit is installed near the display means 50, when the user takes the food in or out, the RF reading unit reads the food information stored in the RFID on the food and/or the food package sheet. In addition, in the case that the RF reading unit is installed in the refrigerator, before/after the user takes the food in or out, the RF reading unit reads the RFID of the food. If the food information is read, the food is put in the refrigerator, and if the food information is not read, the food is taken out of the refrigerator. However, whether the food is taken in or out can be inputted by the input means 10.

The barcode reading unit for reading the barcode printed on the food, the food container or the food packing sheet is installed near the display means 50 for user's convenience. Reading the food information by the barcode reading unit is identical to the general method for reading the barcode. Here, whether the food is taken in or out can be inputted by the input means 10.

The input means 10 and the reading means 30 can be all mounted or selectively mounted.

The date counting means 40 counts and provides the current time periodically or upon the request of the microcomputer 80. The date counting means 40 is operated like a watch to display the current time on the display means 50.

The display means 50 includes a display device and/or a sound device for displaying the avatar formation information, the resultant avatars of the users, images and sounds of the messages, the text messages, the avatars changed from the original avatars of the users, and the biorhythms of the users.

The communication means 60 means a communication interface such as a wire/wireless modem for performing data communication between the microcomputer 80 of the refrigerator 100 and the external server (not shown) through the internet. The communication means 60 can be installed inside or outside the refrigerator 100.

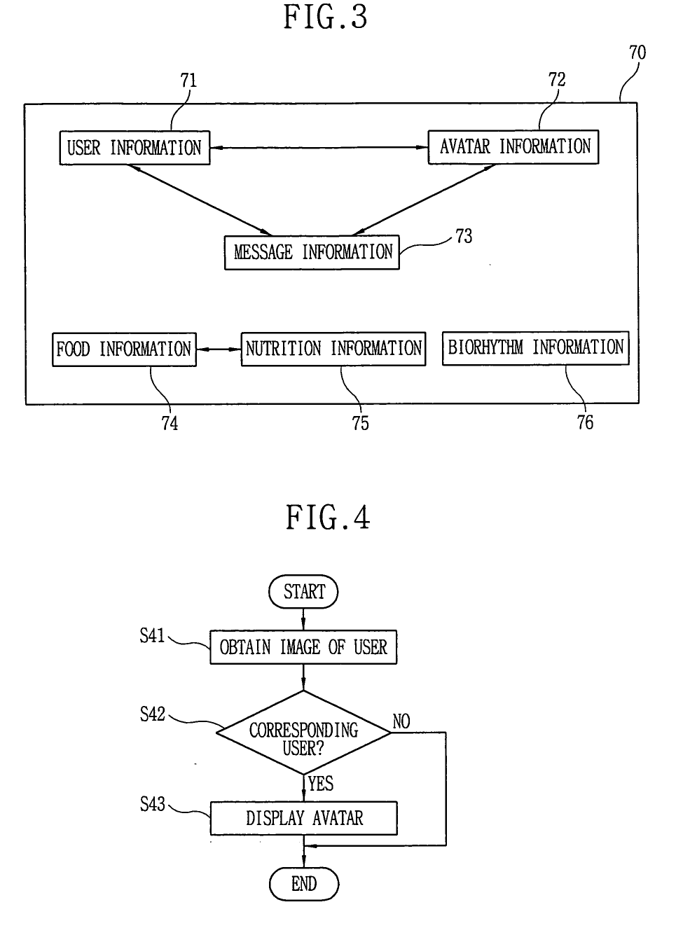

As shown in FIG. 3, the storing means 70 stores the user information, the avatar information and the message information that interwork with each other. Here, the user information for identifying the users includes the images, names and birthdays of the users, and the avatar information includes the avatar formation information which allows the user to select his/her avatar, the resultant avatar and/or the avatars of the whole users, and the avatars recognized in the same manner as the avatars of the users but changed in shape (for example, color, size, slim or fat, etc.). The avatar formation information may include the complete avatars or parts of the avatars (for example, face, body, arms, etc.). Therefore, the users can select the completed avatars, or form the avatars by selecting and combining parts of the avatars.

The message information includes image messages and sound messages obtained by the photographing means 20, and text messages inputted by the input means 10. The user information, the avatar information and the message information interwork with each other. Accordingly, when reading the user information, the microcomputer 80 accesses and reads the corresponding avatar and message information.

The storing means 70 stores food information including a kind and/or quantity of food included in the RFID or barcode of the food, and nutrition information on the nutrition contained in each food. Here, the storing means 70 can individually store the food information of each user. When the user eats the food, the microcomputer 80 reads the food information by the reading means 30, and continuously stores the read food information. The microcomputer 80 obtains the current date from the date counting means 40, and stores the current date with the food information, thereby storing the date when the user eats the food. Therefore, the food information and the nutrition information interwork with each other. When reading the food information of the user, the microcomputer 80 can calculate the quantity of food which the user has ingested for a predetermined period, and decide the nutrition by the ingestion quantity (for example, excess of protein, excess of fat, excess of heat value, etc.).

In addition, the storing means 70 stores biorhythm information for obtaining biorhythms of the users according to the birthdays included in the user information and the current date. The biorhythm information includes physical rhythm information, emotional rhythm information and intellectual rhythm information. The physical rhythm information indicates how the body can adjust to external physical changes, especially, immunity and functions of internal organs. The emotional rhythm information indicates emotions of human beings, especially, feelings or nervous systems controlling such feelings. The intellectual rhythm information indicates brain activity of human beings. Each of the rhythms has a certain period. The physical rhythm has a period of 23 days, the emotional rhythm has a period of 28 days, and intellectual rhythm has a period of 33 days.

The storing means 70 stores the user interface for inputting the message and selecting the user who is a message receiver and/or the corresponding avatar.

The microcomputer 80 generates the user information and forms the avatar by the user. The microcomputer 80 receives the user information from the input means 10, stores the user information in the storing means 70, selects the photographing mode by the input means 10, obtains the image of the user from the photographing means 20, and stores the image of the user in the user information. When the user selects avatar formation, the microcomputer 80 reads the avatar formation information stored in the storing means 70, and displays the avatar formation information on the display means 50. When the user selects the avatar by the input means 10, the microcomputer 80 adds the avatar to the avatar information as the avatar of the user. The microcomputer 80 further receives the avatar formation information from the external server through the communication means 60, stores the avatar formation information, and displays the avatar formation information on the display means 50, so that the user can use the information to form his/her avatar. The microcomputer 80 is ready to search the avatars by identifying the users according to the user information, by interworking the user information with the corresponding avatars or avatar information. The services provided by the microcomputer 80 will now be explained with reference to FIGS. 4 to 7.

FIG. 4 is a flowchart showing a first example of the user avatar display function of the refrigerator in accordance with the present invention.

In detail, in S41, the microcomputer 80 receives selection of the photographing mode from the input means 10, and obtains the image of the user from the photographing means 20. Here, selection of the photographing mode can further include any one of selections of an iris recognition mode, a fingerprint recognition mode and a body shape recognition mode.

In S42, the microcomputer 80 reads the user information stored in the storing means 70, compares the user information with the image of the user, and decides whether the corresponding user and/or user information exists. If the corresponding user and/or user information exists, the routine goes to S43, and if not, the routine ends.

In S43, the microcomputer 80 reads the avatar information interworking with the user and/or user information, and displays the avatar included in the avatar information on the display means 50.

In the first example, the microcomputer 80 displays the previously-stored avatar corresponding to the image of the user on the display means 50.

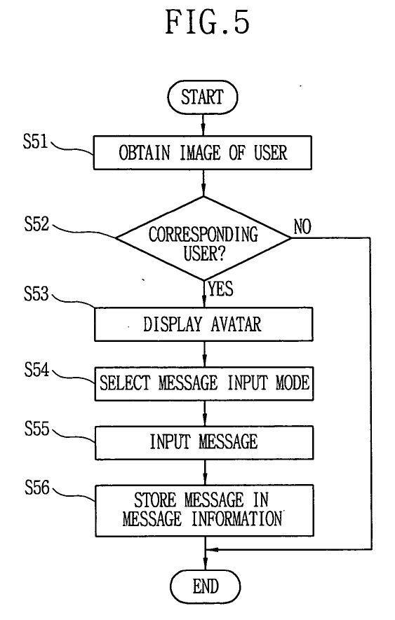

FIG. 5 is a flowchart showing a second example of the user avatar display function of the refrigerator in accordance with the present invention.

In detail, S51 to S53 are identical to S41 to S43 of FIG. 4.

In S54, the microcomputer 80 receives selection of the message input mode from the input means 10, reads the user interface from the storing means 70 for keyboard type input of the text message by the input means 10, displays the user interface on the display means 50, and prepares input of the image and sound messages of the photographing means 20.

In S55, the microcomputer 80 receives the message from the user. The message includes the text message from the input means 10 and the image and sound messages from the photographing means 20, and also includes the user (namely, another user) who is a receiver of the message selected by the user and/or the corresponding avatar.

In S56, the microcomputer 80 stores the message information including the message in the storing means 70, and also stores the user inputting the message and/or the corresponding avatar as a transmitter.

In the second example, the microcomputer 80 displays the previously-stored avatar corresponding to the image of the user on the display means 50, and inputs and stores the message for another user.

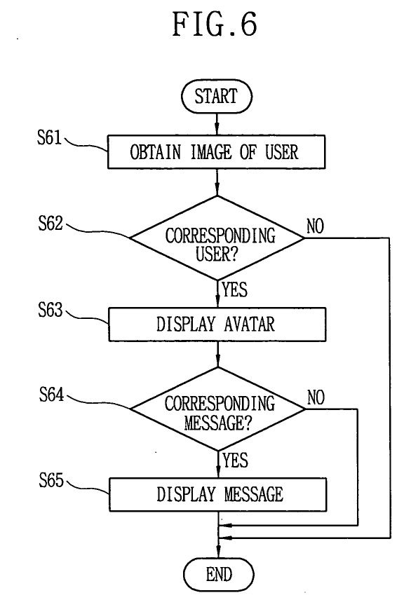

FIG. 6 is a flowchart showing a third example of the user avatar display function of the refrigerator in accordance with the present invention. The third example of FIG. 6 is related to the second example of FIG. 5.

In detail, S61 to S63 are identical to S41 to S43 of FIG. 4.

In S64, the microcomputer 80 decides whether the message information interworking with the user information and/or avatar information read in the previous step includes the message for the user. If so, the routine goes to S65, and if not, the routine ends.

In S65, the microcomputer 80 reads the message for the user, and displays the image, sound or text message on the display means 50. Here, the name of the user who is a transmitter or the corresponding avatar can be displayed.

In the third example, the microcomputer 80 displays the previously-stored avatar corresponding to the image of the user on the display means 50, and searches and displays the message for the user.

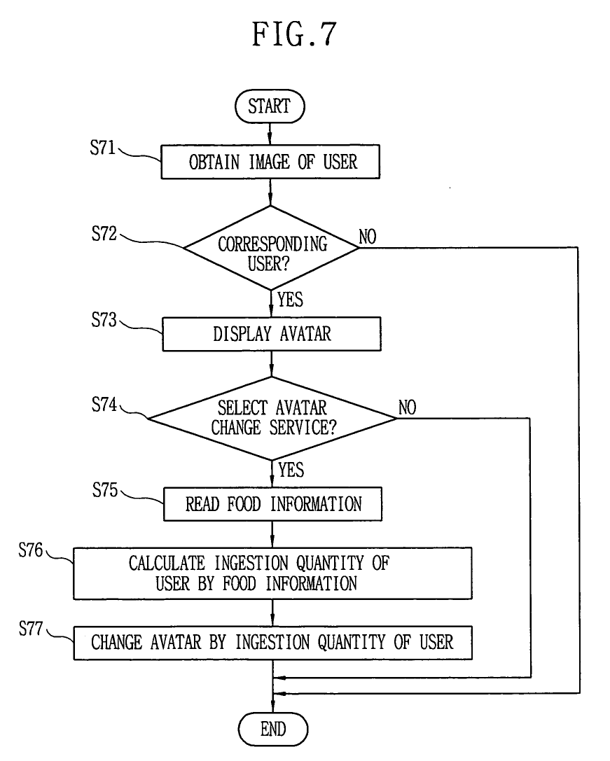

FIG. 7 is a flowchart showing a fourth example of the user avatar display function of the refrigerator in accordance with the present invention.

In detail, S71 to S73 are identical to S41 to S43 of FIG. 4.

In S74, the microcomputer 80 decides whether the user has selected the avatar change service on the previous or current food. If so, the routine goes to S75, and if not, the routine ends.

In S75, the microcomputer 80 reads the food information of the user corresponding to the user information and/or avatar information.

In S76, the microcomputer 80 reads the nutrition information interworking with the read food information, and calculates the quantity of food which the user has ingested for a predetermined period. The ingestion quantity includes the nutrition state of the user. For example, the ingestion quantity can be classified into lack, normal and excess.

In S77, the microcomputer 80 reads the changed avatar from the avatar information of the storing means 70 according to the calculated ingestion quantity of the user, and replaces the current avatar by the changed avatar, thereby visually displaying the ingestion quantity of the user.

In the fourth example, the microcomputer 80 displays the previously-stored avatar corresponding to the image of the user on the display means 50, and changes the avatar according to the ingestion quantity of the user to promote awareness.

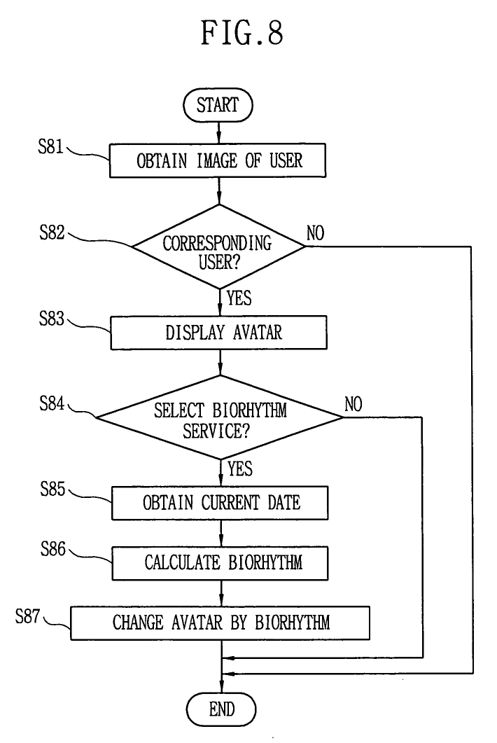

FIG. 8 is a flowchart showing a fifth example of the user avatar display function of the refrigerator in accordance with the present invention.

In detail, S81 to S83 are identical to S41 to S43 of FIG. 4.

In S84, the microcomputer 80 decides whether the user selected or selects the biorhythm service. If so, the routine goes to S85, and if not, the routine ends.

In S85, the microcomputer 80 receives the current date from the date counting means 40.

In S86, the microcomputer 80 obtains a biorhythm by operating the birthday of the user included in the previously-identified user information and the current date (at least the current year, month and day) according to the biorhythm information stored in the storing means 70.

In S87, the microcomputer 80 reads the changed avatar from the avatar information of the storing means 70 according to the biorhythm of the user, and replaces the current avatar by the changed avatar, thereby visually displaying the biorhythm of the user.

In the fifth example, the microcomputer 80 displays the previously-stored avatar corresponding to the image of the user on the display means 50, and changes the avatar according to the biorhythm of the user.

As discussed earlier, in accordance with the present invention, the refrigerator having the user avatar display function identifies the users, and displays the avatars corresponding to the identified users, so that the users can conveniently use the refrigerator.

In addition, the refrigerator having the user avatar display function identifies the users and displays the messages of another users to the identified users, thereby performing message transmission.

Furthermore, the refrigerator having the user avatar display function changes the avatars according to the ingestion quantity of the users, to promote awareness in eating habits of the users.

At last, the refrigerator having the user avatar display function changes the avatars according to the biorhythms showing the states of the users, thereby visually displaying the biorhythm information.

Although the preferred embodiments of the present invention have been described, it is understood that the present invention should not be limited to these preferred embodiments but various changes and modifications can be made by one skilled in the art within the spirit and scope of the present invention as hereinafter claimed.

1. A refrigerator having a user avatar display function, comprising:
a photographing means for photographing images of users;
a storing means for storing user information for identifying the users, and avatar information having avatars corresponding to the users and/or user information;
a display means for displaying the avatars; and
a control means for reading the user information, comparing the user information with the images of the users photographed by the photographing means, reading the avatar information according to the comparison result, and displaying the avatars of the users included in the read avatar information on the display means.

2. The refrigerator of claim 1, wherein the storing means stores message information including messages whose receivers are the users.

3. The refrigerator of claim 2, wherein the messages comprise at least one of image messages, sound messages and text messages.

4. The refrigerator of claim 1, wherein the control means reads the messages corresponding to the avatars of the users from the message information, and displays the messages on the display means.

5. The refrigerator of claim 3, further comprising a speaker unit for providing the sound messages.

6. The refrigerator of claim 1, wherein the images of the users comprise at least one of iris images, fingerprint images and body shapes of the users.

7. The refrigerator of claim 6, wherein the body shapes comprise at least faces.

8. The refrigerator of claim 1, further comprising an input means for receiving commands and/or data from the users.

9. The refrigerator of claim 8, wherein the storing means comprises avatar formation information for forming the avatars, the input means receives selection of the avatars by the users in the avatar formation information, and the control means adds the selected avatars to the avatar information corresponding to the user information.

10. The refrigerator of claim 2, wherein the input means receives selection of the users and/or avatars as receivers, and the control means adds information on the users who are receivers and/or the avatars to the message information.

11. The refrigerator of claim 3, wherein the input means receives the text messages.

12. The refrigerator of claim 1, further comprising a reading means for identifying food information of food taken out of the refrigerator,
wherein the control means adds the food information from the reading means to the user information.

13. The refrigerator of claim 12, wherein the storing means stores nutrition information on foods, and the control means reads the nutrition information, calculates the ingestion quantity of the users according to the food information included in the user information on the basis of the nutrition information, changes the avatars of the users according to the ingestion quantity of the users, and displays the changed avatars on the display means.

14. The refrigerator of claim 1, wherein the storing means stores biorhythm information of the users, and the control means changes the avatars according to the biorhythm information of the users, and displays the changed avatars on the display means.

15. A refrigerator having a user avatar display function, comprising:
a storing means for storing avatar information having avatars corresponding to users;
a display means for displaying the avatars; and
a control means for changing the avatars according to user-related information and displaying the avatars on the display means.

16. The refrigerator of claim 15, wherein the user-related information comprises food information of the foods which the users have ingested.

17. The refrigerator of claim 16, further comprising a reading means for identifying food information of food taken out of the refrigerator,
wherein the control means adds the food information from the reading means to the user-related information as the food information of the foods which the users have ingested.

18. The refrigerator of claim 16, wherein the storing means stores nutrition information on foods, and the control means calculates the ingestion quantity of the users according to the food information on the basis of the nutrition information, changes the avatars of the users according to the ingestion quantity of the users, and displays the changed avatars.

19. The refrigerator of claim 15, wherein the user-related information comprises biorhythm information of the users.
